(19) United States
(12) Patent Application Publication
(10) Pub. No.: US 2014/0132861 A1
(43) Pub. Date: May 15, 2014

(54) TOUCH PANEL AND TOUCH-SENSITIVE DISPLAY DEVICE

(71) Applicant: WINTEK CORPORATION, Taichung City (TW)

(72) Inventors: Wen-Chun Wang, Taichung City (TW); Kuo-Chang Su, Taichung City (TW); Chun-Hui Tseng, Changhua County (TW); Chih-Jung Teng, Taichung City (TW)

(73) Assignee: WINTEK CORPORATION, Taichung City (TW)

(21) Appl. No.: 14/165,553

(22) Filed: Jan. 27, 2014

Related U.S. Application Data
(63) Continuation-in-part of application No. 13/756,091, filed on Jan. 31, 2013.
Application No. 13/756,091 is a continuation-in-part of application No. 13/117,954, filed on May 27, 2011.

(30) Foreign Application Priority Data
May 31, 2010 (TW) 099117358
Jul. 17, 2013 (TW) 102125612

(51) Int. Cl. G06F 1/16

(52) U.S. Cl. CPC G06F 1/169
USPC 349/12

(57) ABSTRACT

A touch panel includes a substrate, a patterned decorative layer, a sensing device, a buffer layer, a plurality of bonding pads, and a protection layer. The substrate has a transparent region and a peripheral region. The patterned decorative layer is disposed in the peripheral region of the substrate. The sensing device is disposed on the substrate and a portion of the sensing device is disposed on the patterned decorative layer. The buffer layer is disposed on the patterned decorative layer. The bonding pads are disposed on the buffer layer and electrically connected to the sensing device. The protecting layer covers the sensing device and has an opening that exposes at least one portion of the buffer layer and the bonding pads.

### CROSS REFERENCE TO RELATED APPLICATIONS

This application is a continuation-in-part of application Ser. No. 13/756,091, filed on Jan. 31, 2013, which is a continuation-in-part of application Ser. No. 13/117,954, filed on May 27, 2011, which claims the benefit of patent application TW No. 099117358, filed on May 31, 2010. This application also claims the benefit of patent application TW No. 102125612, filed on Jul. 17, 2013. This application hereby incorporates by reference the U.S. and international priority applications enumerated herein in their entirety.

### BACKGROUND OF THE INVENTION

1. Field of the Invention

The present invention relates to a touch panel and a touch-sensitive display device including the touch panel, and more particularly, to a touch panel and a touch-sensitive display device that provide protections for the patterned decorative layer in the bonding pad area.

2. Description of the Prior Art

Generally a touch panel is not provided with a protection layer in some area in order to expose a portion of the decorative layer and the bonding pads disposed directly on the surface of the decorative layer, and a bonding process is adopted to bond the exposed bonding pads with external wires to provide signal transmissions and operations. However, in the bonding process, the touch panel may experience UV radiation or high temperatures which cause the exposed decorative layer to be peeled off, discolored, or damaged. In addition, the exposed decorative layer on the surface of the touch panel may also have the problem of scratching in the subsequent processes. Therefore, it is still an important issue for the industry and manufacturer to avoid damages of the decorative layer in the bonding pad area in the fabrication processes.

### SUMMARY OF THE INVENTION

One of the objectives of the present invention is to provide a touch panel and a touch-sensitive display device including the touch panel that includes a buffer layer disposed on the decorative layer to provide protection of the decorative layer and to solve the problems mentioned above in the prior-art touch panel that the decorative layer is easily damaged due to it is exposed on the surface of the touch panel.

To achieve the above objective, the present invention discloses a touch panel. The touch panel includes a substrate, a patterned decorative layer, a sensing device, a buffer layer, a plurality of bonding pads and a protection layer. The substrate has a transparent region and a peripheral region. The patterned decorative layer is disposed in the peripheral region on the substrate. And the sensing device is disposed on the substrate and a portion of the sensing devices is disposed on the patterned decorative layer. The buffer layer is disposed on the decorative layer. The bonding pads are disposed on the buffer layer, and the bonding pads are electrically connected to the sensing device. The protection layer covers the sensing device and has an opening exposing at least one portion of the buffer layer and the bonding pads.

To achieve the above objective, the embodiment of the present invention also discloses a touch-sensitive display device. The touch-sensitive display device includes a touch panel as described above, a display panel and an adhesive layer. Wherein the display panel is disposed at one side of the touch panel and the adhesive layer is disposed between the display panel and the touch panel for fixing the touch panel onto the surface of the display panel.

Since the touch panel of the present invention includes a buffer layer disposed between the patterned decorative layer and the bonding pads, and the buffer layer covers the patterned decorative layer in the opening of the protection layer, it provides protection for the patterned decorative layer to avoid the damages of the patterned decorative layer caused by high temperature, UV radiation, or other factors in the subsequent fabrication processes. As a result, it may improve the product yield.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the partial top view of a touch panel according to the first embodiment of the present invention.

FIG. 2 is a schematic diagram of the partial cross-sectional view along the cross line A-A′ of the touch panel shown in FIG. 1.

FIG. 3 is a schematic diagram of the partial cross-sectional view of the touch-sensitive display device of the present invention.

FIG. 4 is a schematic diagram of the partial cross-sectional view of a touch panel according to a variant embodiment of the first embodiment of the present invention.

FIG. 5 is a schematic diagram of the partial top view of a touch panel according to the second embodiment of the present invention.

FIG. 6 is a schematic diagram of the partial cross-sectional view of a touch panel according to the second embodiment of the present invention.

FIG. 7 is a schematic diagram of the partial top view of a touch panel according to the third embodiment of the present invention.

FIG. 8 is a schematic diagram of the partial cross-sectional view of a touch panel according to the third embodiment of the present invention.

FIG. 9 is a schematic diagram of the partial top view of a touch panel according to the fourth embodiment of the present invention.

FIG. 10 is a schematic diagram of the partial cross-sectional view of a touch panel according to the fourth embodiment of the present invention.

FIG. 11 is a schematic diagram of the cross-sectional view of a touch panel according to the fifth embodiment of the present invention.

### DETAILED DESCRIPTION

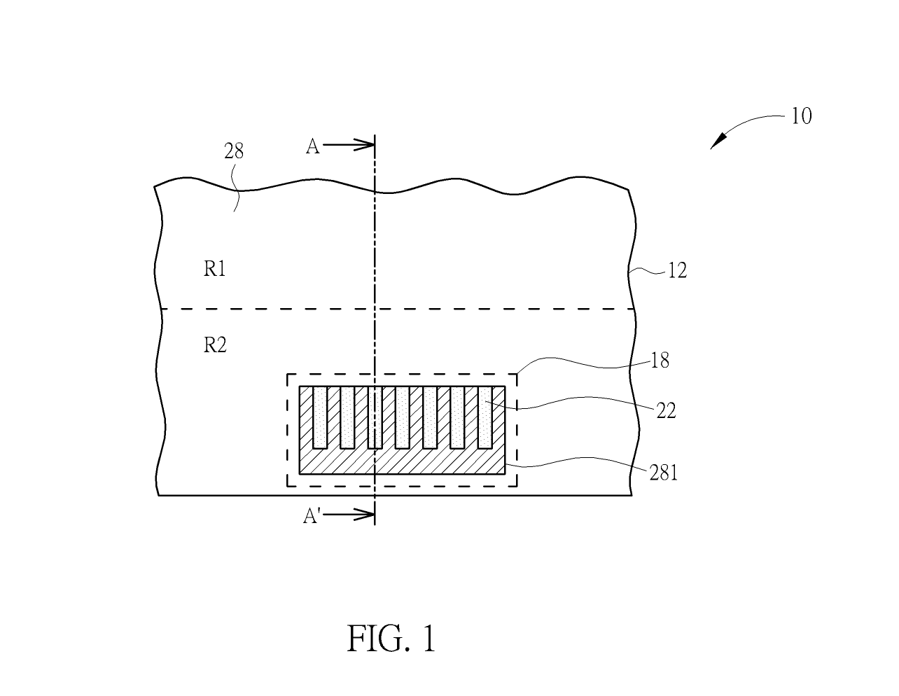

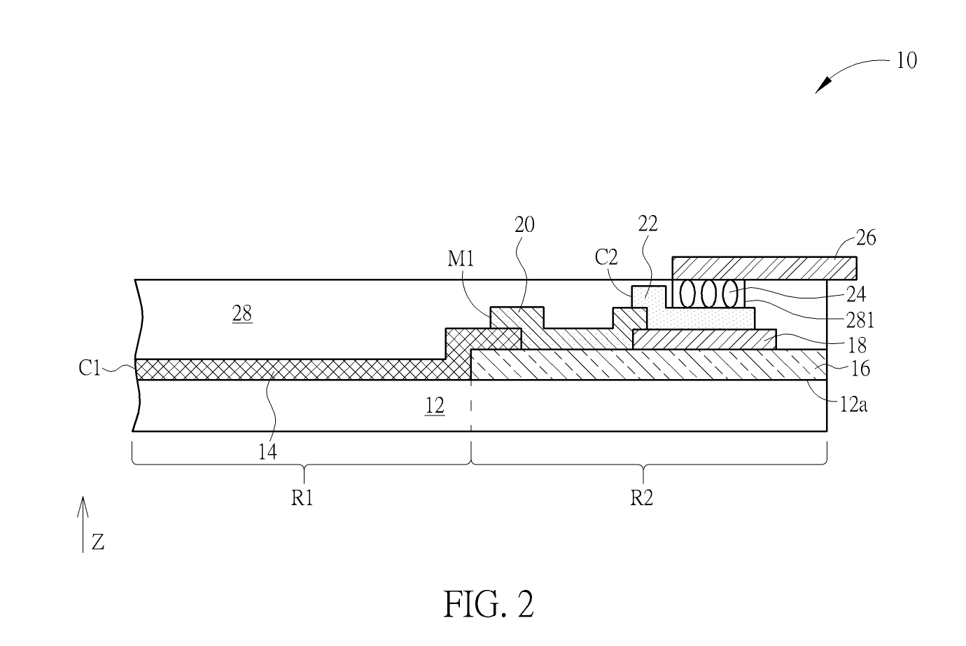

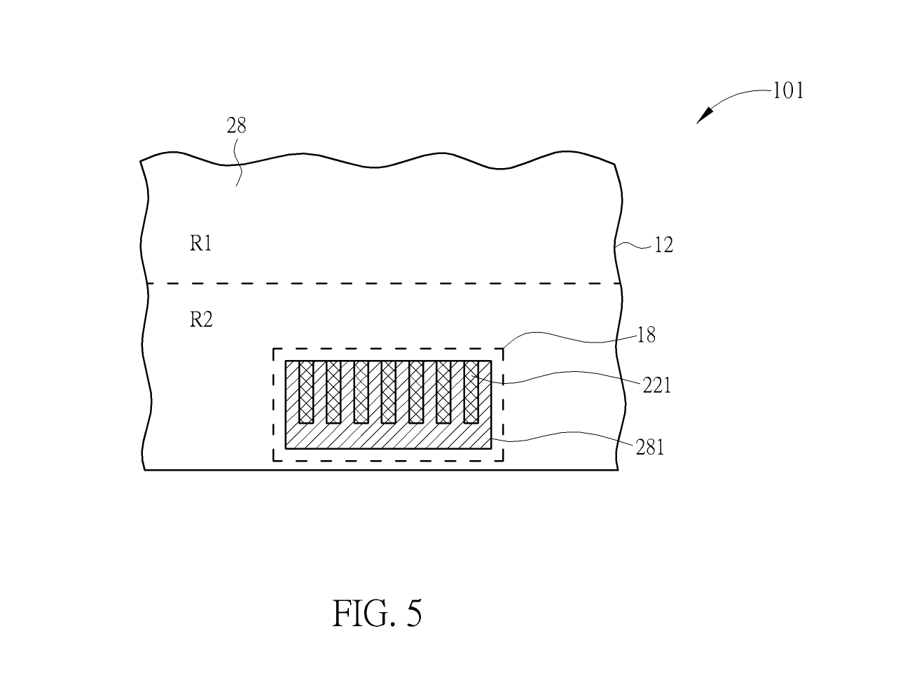

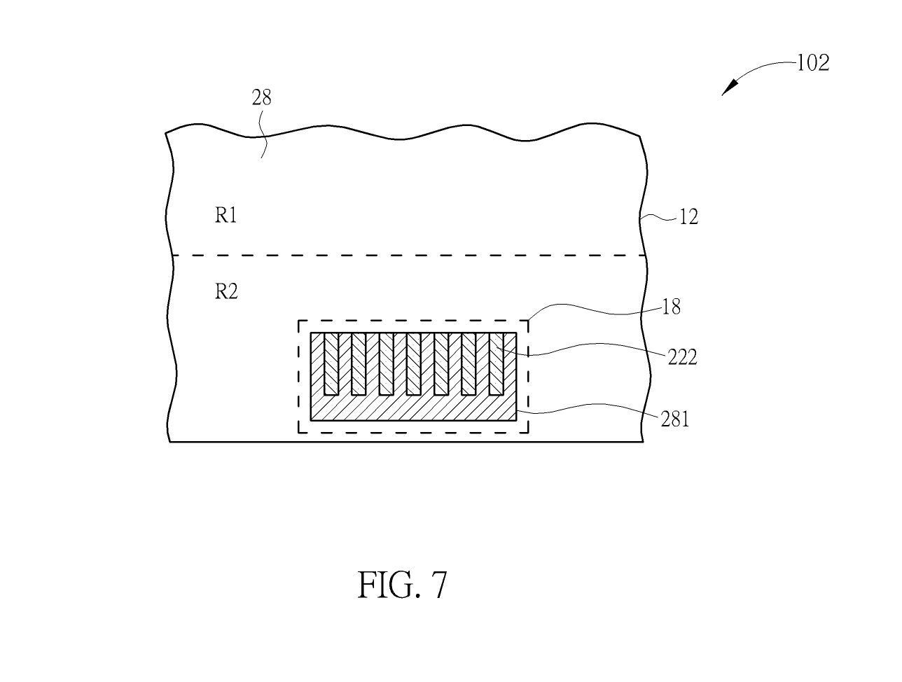

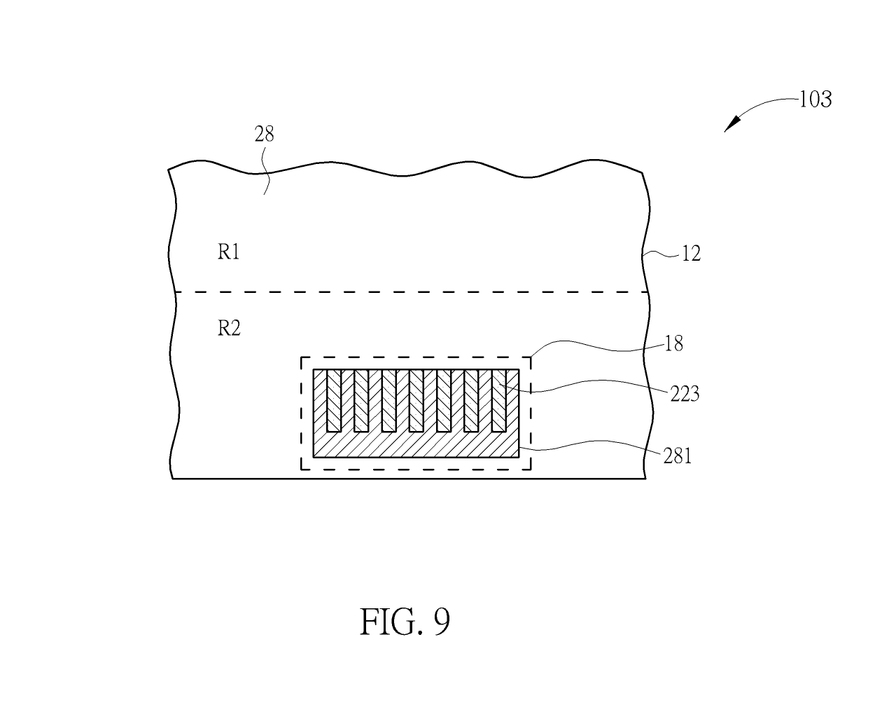

Please refer to FIG. 1 and FIG. 2. FIG. 1 is a schematic diagram of the partial top view of a touch panel according to the first embodiment of the present invention, and FIG. 2 is a cross-sectional schematic diagram along the cross-line A-A′ of the touch panel shown in FIG. 1. However, please note that FIG. 1 only depicts the protection layer 28 and the components below the protection layer 28, and does not depict the circuit connection board 26 and the conductive adhesive layer 24 indicated in FIG. 2. Besides, the top views in the following FIG. 5, FIG. 7, and FIG. 9 do not depict the circuit connection board 26 and the conductive adhesive layer 24 either.

As shown in FIG. 1 and FIG. 2, the touch panel 10 of the present invention includes a substrate 12. The substrate 12 has a transparent region R1 and a peripheral region R2 defined thereon. The peripheral region R2 is disposed on at least one side of the transparent region R1. For example, the peripheral region R2 of this embodiment may be disposed around the transparent region R1 such that the peripheral region R2 may have a shape as a ring or a closed square frame. Since FIG. 1 only depicts a portion of the touch panel 10, it depicts only one portion of the peripheral region R2 adjacent to the transparent region R1. Please note that the present invention is not limited to this embodiment and the peripheral region R2 may be disposed only adjacent to some portions of the edges of the transparent region R1 as needed. The touch panel 10 of the present invention further includes a sensing device 14, a patterned decorative layer 16, a buffer layer 18, a plurality of bonding pads 22 and a protection layer 28. Wherein, the patterned decorative layer 16 is disposed in the peripheral region R2 on the surface 12a of the substrate 12. The sensing device 14 is disposed at least in the transparent region R1 on the surface 12a of the substrate 12. Therefore, the patterned decorative layer 16 and the sensing device 14 are disposed respectively on one portion of the surface 12a of the substrate 12, and both of them do not overlap each other with at least one portion. It should be noted that since the peripheral region R2 is not necessarily disposed as a ring or a closed square frame in other embodiments, thus the patterned decorative layer 16 does not necessarily have a ring-like pattern or a closed pattern. For example, the patterned decorative layer 16 may be disposed only on the upper side and lower side of the display panel 10, but not on the left side and right side of the display panel 10, but not limited thereto. The buffer layer 18 is disposed on the patterned decorative layer 16 and covers a portion of the patterned decorative layer 16. The bonding pads 22 are disposed on the buffer layer 18 and are electrically connected to the sensing device 14. Also, the area of the buffer layer 18 is preferably smaller than the area of the patterned decorative layer 16. As shown in FIG. 1, the display panel 10 may include a plurality of bonding pads 22, parallel to each other, side by side and spaced by a certain distance. Therefore, portions of the buffer layer 18 are exposed between the adjacent bonding pads 22. According to the preferred embodiment, a portion of the sensing device 14 extends to the peripheral region R2 of the surface 12a of the substrate 12 and partially covers one portion of the patterned decorative layer 16, which means the portion of the sensing device 14 is disposed on the surface of the patterned decorative layer 16. The sensing device 14 is electrically connected to the bonding pads 22 through one to several signal wires 20 disposed on the patterned decorative layer 16. Moreover, the protection layer 28 is disposed on the buffer layer 18, the bonding pads 22, the signal wires 20, and the sensing device 14, and completely covers the surface 12a of the substrate 12 and also covers the sensing device 14. The protection layer 28 has an opening 281. Wherein the opening 281 exposes at least a portion of the bonding pads 22, the buffer layer 18, the patterned decorative layer 16, and the substrate 12 in the vertical projection direction Z. Wherein the area of the buffer layer 18 is larger than or equal to the area of the opening 281, and the area of the buffer layer 18 is preferably larger than the area of the opening 281. It should be noted that since the buffer layer 18 covers the patterned decorative layer 16 and its area is larger than or equal to the area of the opening 281, the buffer layer 18 completely covers the patterned decorative layer 16 disposed thereunder in the opening 281. Namely in fact the only layers exposed by the opening 281 are the buffer layer 18 and the bonding pads 22 from the top side of FIG. 2. In addition, the touch panel 10 may also include a circuit connection board 26, such as a flexible printed board (FPC), disposed on protection layer 28 and covering the opening 281. The circuit connection board 26 is electrically connected to the bonding pads 22 by the conductive adhesive layer 24. Wherein the conductive adhesive layer 24 is disposed in the opening 281 and between the circuit connection board 26 and the bonding pads 22 exposed by the opening 281. The conductive adhesive layer 24 may be an anisotropic conductive film (ACF), for example, but is not limited thereto.

Following is the introduction of the materials and relative positions of the components of the touch panel 10. According to this embodiment, the substrate 12 may be a glass substrate, a thin glass layer, a plastic plate, a complex plastic plate, or a plastic thin film. The light transmittance ratio of the substrate 12 is preferably greater than or equal to 85%. The patterned decorative layer 16 may include any color materials, such as an ink layer or a photoresist layer. In this embodiment, the patterned decorative layer 16 has one single dark ink layer as an example, but it is not limited thereto. For example, the patterned decorative layer 16 may include two or more layers. The material of the buffer layer 18 includes at least one of silicon nitride (SiNx), silicon oxide (SiOx), and index matching materials. The possible index matching materials may be materials such as titanium oxide (TiO₂), Niobium oxide (NbOₓ), and aluminum oxide (Al₂O₃). However, the material of the buffer layer 18 is not limited to the above. Any other materials that can protect the patterned decorative layer 16 may be utilized to be the buffer layer 18. Moreover, the buffer layer 18 may be a structure of a single layer or a stack structure of a plurality of layers. For example, the buffer layer 18 may be composed of at least one of a silicon nitride layer, a silicon oxide layer, and an organic material layer. Namely the buffer layer 18 may be a stack structure of two or more layers of the layers mentioned above. In addition, the sensing device 14, the signal wires 20, and the bonding pads 22 are respectively composed of materials with conductivity, such as metal oxide, metal, or other conductive materials such as layers including nano-metal materials. Besides, the sensing device 14 can detect touch by the self-capacitance or the mutual capacitance. The self-capacitance is based on measuring variance of the capacitance of at least one single electrode against an object, such as a finger or a stylus, with respect to the ground. The mutual capacitance is based on measuring variance of the mutual capacitance between a driving electrode and a receiving electrode. In the case of self-capacitance, the sensing device 14 can be composed of single electrodes and each of the single electrodes has a function of independent driving and sensing. In the case of mutual-capacitance, the sensing device 14 can be composed of driving electrodes and receiving electrodes. In this embodiment, the touch panel 10 is a single-layered multi-touch projective capacitive touch panel, and the touch panel 10 may include a plurality of sensing devices 14 to form a plurality of first axial electrodes and second axial electrodes for example, wherein the first axial electrodes and the second axial electrodes are insulated from each other and respectively extend along different directions that they intersect with each other or they are perpendicular to each other. The sensing devices 14 (or portions of the first axial electrodes and the second axial electrodes) are composed of a first conductive layer C1. Some sensing devices 14 are electrically connected to each other respectively through bridge connection elements (not shown in the figure). The bonding pads 22 and the bridge connection elements may be composed of the same second conductive layer C2. In other words, the bonding pads 22 and the bridge connection elements of the sensing devices 14 can be formed through the same fabrication process steps simultaneously. In this embodiment, in terms of the order of the fabrication or the distance from the surface 12a of the substrate 12 (i.e. the high or low positions of both layers on the horizontal plane) being concerned, the second conductive layer C2 is disposed above the first conductive layer C1, which means the first conductive layer C1 is nearer the surface 12a of the substrate 12 than the second conductive layer C2, but is not limited thereto. In other embodiments, the bridge connection elements may be fabricated before the sensing devices 14 are fabricated, while the sensing devices 14 and the bonding pads 22 may be designed to be fabricated by the same conductive layer. Also, in different embodiments, the shape and structures of the sensing devices 14 may have much variety in design. For example, the sensing devices 14 may be a plurality of triangle sensing devices disposed side-by-side with an upside-down arrangement, a plurality of rectangular sensing devices separated from each other, or sensing devices in other geometric shapes. In this case, the touch panel 10 does not need bridge connection elements for electrically connecting the sensing devices 14 to form axial electrodes. In addition, the present invention is not limited to the above. Based on the requirement of design, sensing devices in other regular or irregular shapes may be used and uniformly distributed in the transparent region R1. For example, the collocation of a plurality of strip-shaped sensing devices and a plurality of lump-shaped sensing devices disposed between two adjacent strip-shaped sensing devices may be used. The first conductive layer C1 and the second conductive layer C2 in this embodiment are respectively transparent conductive layers. The materials may be, for example, indium tin oxide (ITO), indium zinc oxide (IZO), aluminum zinc oxide (AZO), and may also be other metal oxide materials or any other suitable transparent conductive materials. However, in other embodiments, the first conductive layer C1 and the second conductive layer C2 may also include conductive materials other than transparent conductive materials, such as a metal mesh layer, a nano-metal material layer or a nano conductive layer, or the first conductive layer C1 and the second conductive layer C2 may respectively have a stack structure of different material layers mentioned above. The materials, for example, may be metal, metal oxide, carbon nanotubes, or nano-silver yarns. The metal mesh layer is, for example, a stack structure of molybdenum/aluminum/molybdenum (Mo/Al/Mo), or molybdenum-oxide/aluminum/molybdenum (MoOx/Al/Mo), or molybdenum-oxide/molybdenum/aluminum/molybdenum (MoOx/Mo/Al/Mo), but not limited thereto. Similar stack structures of other materials may also be used, such as a stack structure of coppers (Cu) and metal oxides. The above materials, the patterns of the layers, and the stack structures may also be used in all embodiments of the present invention. Besides, the signal wires 20 electrically connecting the sensing devices 14 and the bonding pads 22 are composed of a third conductive layer M1. The materials of the signal wires 20 may include, for example, metal oxide, metal, or other conductive materials. When the third conductive layer M1 is a metal layer, its material may be, for example, silver, aluminum, copper, magnesium, molybdenum, or the alloy of the above materials. When the third conductive layer M1 is a transparent conductive layer, its material may include any of the transparent conductive materials used for forming the first and the second conductive layers C1, C2 as mentioned above, but not limited thereto. The third conductive layer M1 partially overlaps with the first conductive layer C1 and the second conductive layer C2 respectively so as to be electrically connected to the first conductive layer C1 and the second conductive layer C2. The protection layer 28 is composed of at least one of a silicon nitride (SiNx) layer, a silicon oxide (SiOx) layer, and an organic material layer. When the protection layer 28 is an organic material layer, its thickness is greater than the thickness of the sensing devices 14. In this embodiment, the protection layer 28 may be used as a planarization layer. As a result, the fabrication order in this embodiment is first to form the patterned decorative layer 16 on the surface 12a of the substrate 12 in the peripheral region R2, then to form the sensing devices 14 and the buffer layer 18, later on to sequentially form the signal wires 20 and the bonding pads 22, and finally to form the protection layer 28 on the whole surface 12a of the substrate 12 and form an opening 281 in the corresponding portion of the bonding pads 22. After that, the conductive adhesive layer 24 is used to fix the circuit connection board 26 onto the opening 281 to make the circuit connection board 26 electrically connected to the bonding pads 22, the signal wires 20, and the sensing devices 14. However, the fabrication order of the touch panel 10 of the present invention is not limited to the above. For example, the signal wires 20 may be first formed on the patterned decorative layer 16, then the sensing devices 14 and the bonding pads 22 are sequentially formed; or the signal wires 20 are formed first, and then the bonding pads 22 and the sensing devices 14 are sequentially formed.

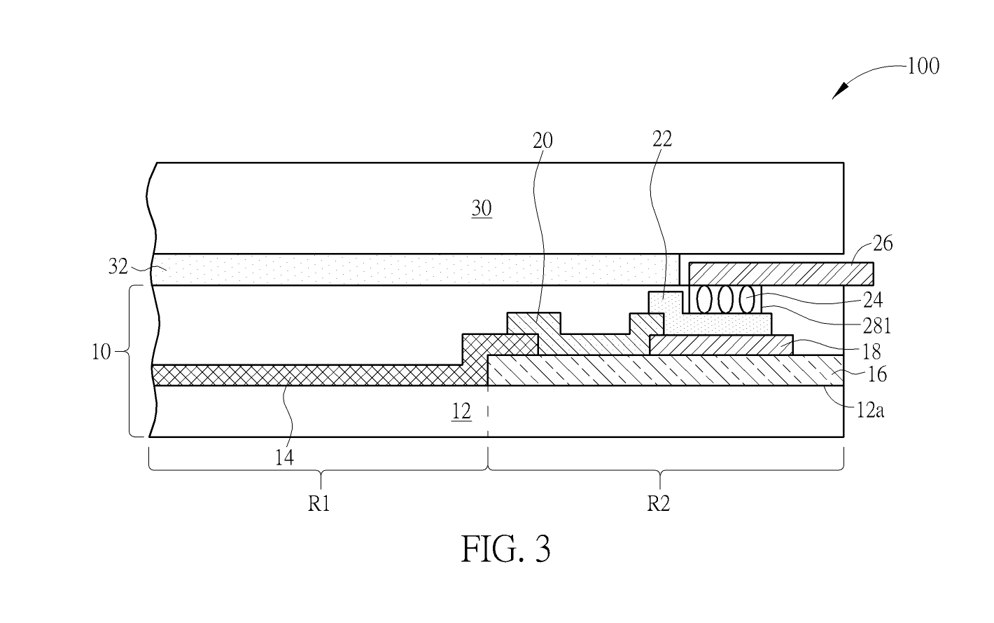

Please refer to FIG. 3. The touch panel 10 of the present invention may be applied to a touch-sensitive display device 100. The touch-sensitive display device 100 includes the touch panel 10 of the present invention as mentioned above, a display panel 30 and an adhesive layer 32. Wherein the display panel 30 is disposed at one side of the touch panel 10, and the adhesive layer 32 is disposed between the display panel 30 and the touch panel 10 to fix the touch panel 10 on the surface of the display panel 30. Wherein the display panel 30, for example, may be, but not limited to, a liquid crystal display panel, an organic light-emitting display panel, an electrowetting display panel, or an electrophoretic display panel. Based on the above description, since the buffer layer 18 disposed on the surface of the patterned decorative layer 16 provides the protection for the patterned decorative layer 16, the damages of the patterned decorative layer 16 caused by the subsequent fabrication processes, either binding circuit connection board 26 or fixing the touch panel 10 onto the display panel 30, will be effectively avoided.

The different implementation states and embodiments of the touch panel of the present invention will be explained below. To simplify the explanation, the following description will focus mainly on the details of the differences among embodiments, rather than repeating their similarities. Besides, the similar components in each embodiment of the present invention will be labeled with the same numeral labels in order to facilitate comparisons among embodiments.

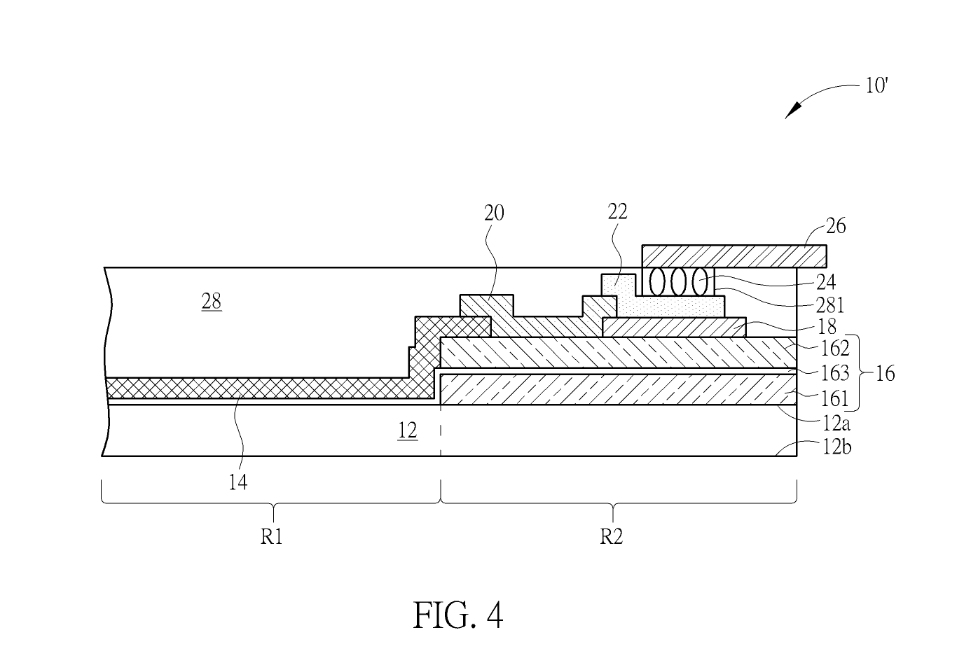

Please refer to FIG. 4. In the variant embodiment of the first embodiment of the touch panel of the present invention, the patterned decorative layer 16 of the touch panel 10′ includes a first sub-patterned decorative layer 161 and a second sub-patterned decorative layer 162 disposed on the surface 12a of the substrate 12 from bottom to top in order. The color of the first sub-patterned decorative layer 161 is non-black, non-dark, or light, such as white or pink, but not limited thereto. The light transmittance ratio of the first sub-patterned decorative layer 161 is greater than the light transmittance ratio of the second sub-patterned decorative layer 162, which means that the optical density of the first sub-patterned decorative layer 161 is smaller than the optical density of the second sub-patterned decorative layer 162. Since the first sub-patterned decorative layer 161 includes non-black materials, in order to prevent users to see the components behind the first sub-patterned decorative layer 161 on the surface 12a of the substrate 12 due to insufficient coverage effect of the first sub-patterned decorative layer 161, this variant embodiment includes a second sub-patterned decorative layer 162 with low light transmittance ratio to cover the other components on the patterned decorative layer 16, such as the signal wires 20 and the bonding pads 22, and so on. In this variant embodiment, the first sub-patterned decorative layer 161 and the second sub-patterned decorative layer 162 are both composed of photoresist materials. For example, the first sub-patterned decorative layer 161 includes white photoresist materials, and the second sub-patterned decorative layer 162 includes black photoresist materials, but not limited thereto. Moreover, in order to prevent unclear mix of the colors of the first sub-patterned decorative layer 161 and the second sub-patterned decorative layer 162, a separation layer 163 may be disposed optionally between the first sub-patterned decorative layer 161 and the second sub-patterned decorative layer 162, and the separation layer 163, as indicated in the diagram, may extend to the transparent region R1, wherein the sensing devices 14 in the transparent region R1 are disposed on the separation layer 163. The materials of the separation layer 163, for example, may include, but not limited to, silicon nitride, silicon oxide, index matching materials, or materials the same as the buffer layer 18.

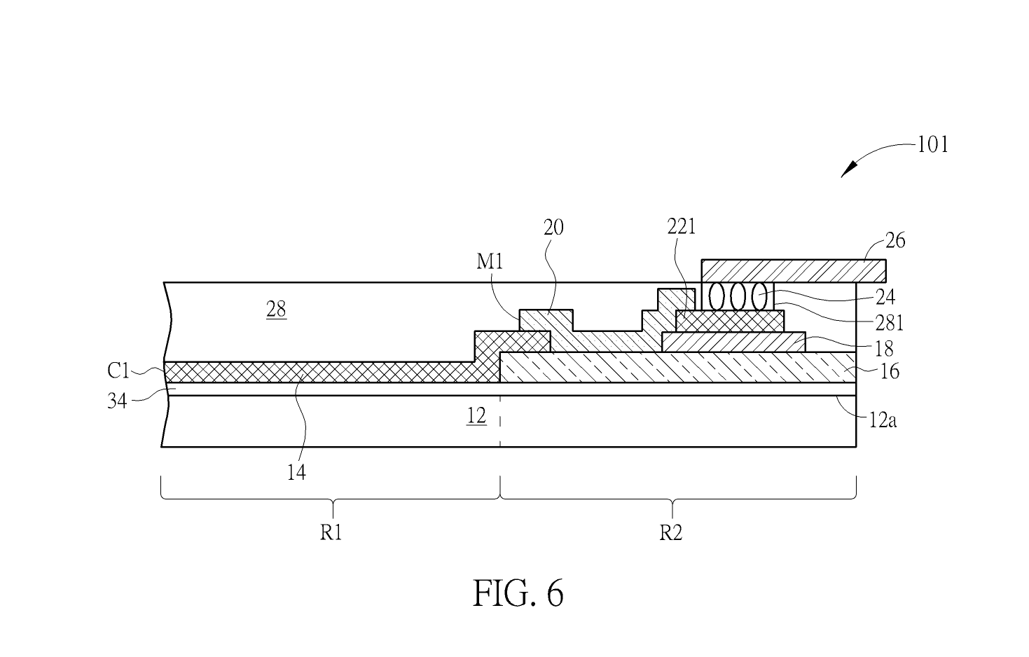

Please refer to FIG. 5 and FIG. 6, which are respectively a schematic diagram of the partial top view and a schematic diagram of the partial cross-sectional view of the touch panel according to the second embodiment of the present invention. The touch panel 101 in this embodiment is different from that in the first embodiment in that the bonding pads 221 and the sensing devices 14 are composed of the same first conductive layer C1. Therefore, the bonding pads 221 and the sensing devices 14 may be fabricated in the same fabrication process, and then the signal wires 20 and the protection layer 28 will be formed in order on the bonding pads 221 and the sensing devices 14. For example, the first conductive layer C1 may include at least one of a metal mesh structure, a metal oxide layer, and a nano-metal material layer. However, the fabrication order of the touch panel 101 of the present invention is not limited to the above. For example, the signal wires 20 may be made first, and then the sensing devices 14 and the bonding pads 221 will be made in the same fabrication process. Moreover, the touch panel 101 in this embodiment also includes an insulating layer 34 disposed between the substrate 12 and the sensing devices 14, as well as the patterned decorative layer 16. The refraction index of the insulating layer 34 is preferably between 1.4˜1.9. The material of the insulating layer 34, for example, is silicon dioxide.

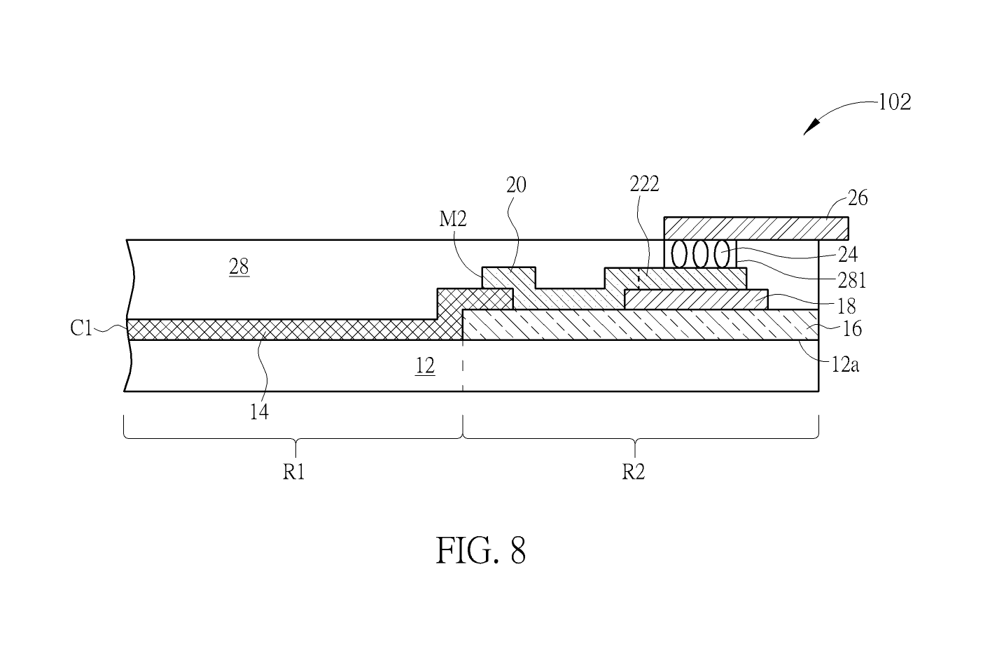

Please refer to FIG. 7 and FIG. 8, which are respectively a schematic diagram of the partial top view and a schematic diagram of the partial cross-sectional schematic diagram of the touch panel according to the third embodiment of the present invention. The touch panel 102 in this embodiment is different from that in the first embodiment in that the bonding pads 222 and the signal wires 20 are composed of the same second conductive layer M2. It may also be regarded as that the signal wires 20 in this embodiment directly extend outward to form the bonding pads 222. As a result, no other conductive layer is needed form forming the bonding pads 222. The materials of the second conductive layer M2 may be the same as the materials of the third conductive layer M1 mentioned in the first embodiment, such as a metal layer or a metal oxide layer. Please note that, in s variant embodiment, the signal wires 20 and the bonding pads 222 may be formed before the sensing devices 14.

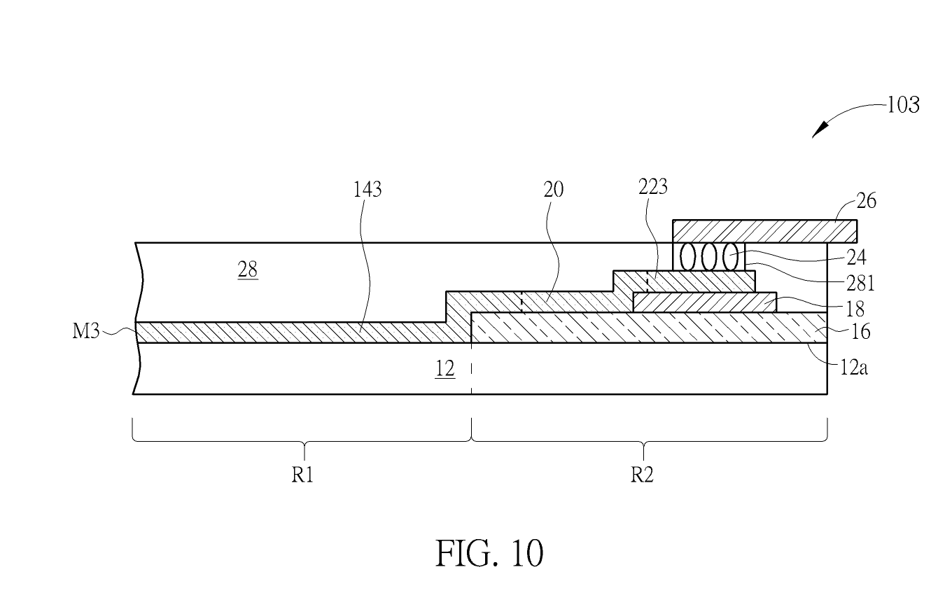

Please refer to FIG. 9 and FIG. 10, which are respectively a schematic diagram of the partial top view and a schematic diagram of the partial cross-sectional view of the touch panel according to the fourth embodiment of the present invention. The touch panel 103 in this embodiment is different from that in the first embodiment in that the sensing devices 143, the bonding pads 223, and the signal wires 20 of the touch panel 103 are composed of the same conductive layer M3. In other words, the conductive layer M3 used for forming the conductive electrodes 143 in the transparent region R1 extends directly to the peripheral region R2 and also forms the signal wires 20 and the bonding pads 223. Alternatively, it may also be regarded as that the touch panel 103 does not include signal wires, but the sensing devices 143 directly extend to the peripheral region R2 and connects to the bonding pads 223. Wherein the conductive layer M3 may include metal materials or metal oxide materials. In the preferable embodiment, the conductive layer M3 may be composed of metal materials. For example, it may include a patterned metal mesh structure or the conductive layer M3 itself is a metal mesh layer. In different embodiments, the conductive layer M3 may also be a nano-metal material layer. For example, it may include nano-silver yarns that are formed by printing process, inkjet process, or processes of coating, curing and etching. In addition, the conductive layer M3 may also include carbon nanotubes or other suitable conductive materials.

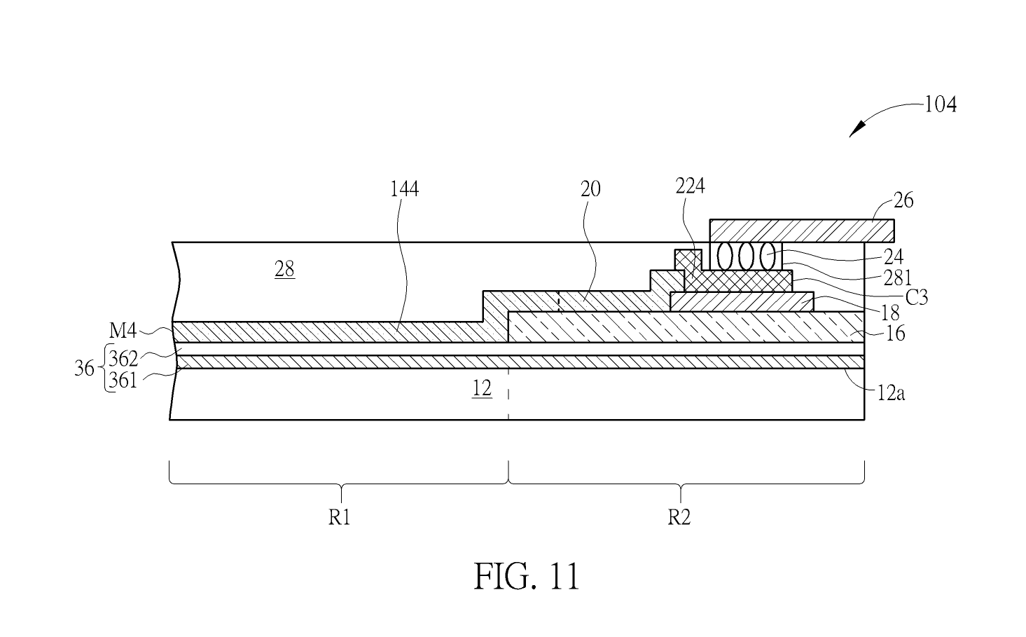

Please refer to FIG. 11, which is a schematic diagram of the partial cross-sectional view of a touch panel according to the fifth embodiment of the present invention. This embodiment is different from the first embodiment in that the signal wires 20 and the sensing devices 144 are composed of the same conductive layer M4, while the bonding pads 224 are composed of another conductive layer C3. In other words, the signal wires 20 may be regarded as being directly formed by the same material layer of the sensing devices 144 which extends toward the peripheral region R2 to the surface of the buffer layer 18 and the top surface of the patterned decorative layer 16. The conductive layer C3 and the conductive layer M4 partially overlap each other such that the signal wires 20 and bonding pads 224 are electrically connected to each other. The conductive layer M4 may include any materials mentioned above for the sensing devices, and the conductive layer C3 may include any materials mentioned above for bonding pads. Moreover, the touch panel 104 of this embodiment also includes an index matching layer 36 disposed on the substrate 12 and under the sensing devices 144 and the patterned decorative layer 16. The index matching layer 36 may be a single-layer structure or a complex-layer structure. The index matching layer 36 in this embodiment, for example, is formed by a stack structure of a first index matching layer 361 and a second index matching layer 362. For example, the material of the first index matching layer 361 is silicon nitride (SiNx) and the second index matching layer 362 is silicon oxide (SiOx), but not limited thereto.

The above embodiments introduce the relative fabrication processes and materials of various kinds of the sensing device, signal wires, bonding pads, and the bridge connection elements of the sensing devices, wherein at least two of the sensing device, the signal wires, and the bonding pads may be fabricated by the same process to save fabrication time and costs. Moreover, the patterned decorative layer with multi layers in the variant embodiment of the first embodiment may be applied to every other embodiment. In addition, the designs of the multi-layer patterned decorative layer disclosed in the variant embodiment and the fabrication variation of the sensing device, the signal wires, and the bonding pads may be applied to all kinds of the touch-sensitive display device including the display panel of the present invention, such as the touch-sensitive display device shown in FIG. 3. Furthermore, the insulating layer and the index matching layer disposed between the sensing device and the substrate shown in FIG. 6 and FIG. 11 may also be applied to other embodiments. Similar applications will not be repeated and given unnecessary details. In addition, the display panel of the present invention is not limited to the single-layered multi-touch projective capacitive touch panel, and it may also be a double-layered sensing device touch panel or a double-substrate touch panel. The sensing device(s) may include all kinds of installation methods and shapes.

As mentioned above, since the buffer layer of the touch panel and the touch-sensitive display device of the present invention is larger than or equal to the opening of the protection layer, the buffer layer completely covers the patterned decorative layer in the opening to avoid the exposure of the patterned decorative layer on the surface of the display panel, and furthermore to avoid the situations of deformation, reduced adhesion, peeling, and discoloration of the patterned decorative layer caused by the subsequent fabrication processes, such as the process to electrically connect the bonding pads with the external components or the UV radiation process. This design will also effectively avoid the problems of scratching and breakage of the patterned decorative layer. Accordingly, by positioning a buffer layer between the bonding pads and the patterned decorative layer according to the present invention will maintain the appearance of integrity of the touch panel and improve the product yield.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate, having a transparent region and a peripheral region defined thereon;
a patterned decorative layer, disposed in the peripheral region on the substrate;
a sensing device, disposed on the substrate, a portion of the sensing device being disposed on the patterned decorative layer;
a buffer layer, disposed on the patterned decorative layer;
a plurality of bonding pads, disposed on the buffer layer and electrically connected to the sensing device; and
a protection layer, covering the sensing device, wherein the protection layer has an opening that exposes at least one portion of the buffer layer and the bonding pads.

2. The touch panel of claim 1, further comprising:
a circuit connection board, disposed on the protection layer; and
a conductive adhesive layer, disposed between the bonding pads and the circuit connection board, the circuit connection board being electrically connected to the bonding pads through the conductive adhesive layer.

3. The touch panel of claim 1, wherein an area of the buffer layer is greater than or equal to an area of the opening.

4. The touch panel of claim 3, wherein an area of the buffer layer is less than an area of the patterned decorative layer.

5. The touch panel of claim 3, wherein the buffer layer is composed of at least one of a silicon nitride (SiNx) layer, a silicon oxide (SiOx) layer and an organic material layer.

6. The touch panel of claim 1, wherein a material of the buffer layer comprises at least one of silicon nitride, silicon oxide, and an index matching material.

7. The touch panel of claim 6, wherein the index matching material is titanium oxide (TiO₂), niobium oxide (NbOₓ) or aluminum oxide (Al₂O₃).

8. The touch panel of claim 1, wherein materials of the bonding pads and the sensing device respectively comprise at least one of indium tin oxide (ITO), indium zinc oxide (IZO), aluminum zinc oxide (AZO), nano-silver yarns, carbon nanotubes, metal oxide and metal.

9. The touch panel of claim 1, further comprising a plurality of signal wires disposed on the patterned decorative layer, the signal wires being electrically connected to the sensing device, the signal wires comprising a conductive layer different from a conductive layer of the bonding pads, and the conductive layer of the signal wires at least partially overlapping with the conductive layer of the bonding pads such that the signal wires are electrically connected to the bonding pads.

10. The touch panel of claim 1, wherein the sensing device comprises a conductive layer, the conductive layer extending to a top surface of the patterned decorative layer to form a plurality of signal wires and the bonding pads.

11. The touch panel of claim 10, wherein a material of the conductive layer comprises at least one of metal, metal oxide, nano-metal material, nano-silver yarns and carbon nanotubes.

12. The touch panel of claim 10, wherein the sensing device, the bonding pads and the signal wires are composed of a same conductive layer.

13. The touch panel of claim 1, wherein the sensing device comprises a patterned metal mesh layer.

14. The touch panel of claim 1, wherein the patterned decorative layer comprises two or more layers.

15. The touch panel of claim 14, wherein the patterned decorative layer comprises a first sub-patterned decorative layer and a second sub-patterned decorative layer disposed on the substrate from bottom to top in order, the first sub-patterned decorative layer comprises a non-black color material, and the first sub-patterned decorative layer has a light transmittance ratio greater than a light transmittance ratio of the second sub-patterned decorative layer.

16. The touch panel of claim 15, wherein the patterned decorative layer further comprises a separation layer disposed between the first sub-patterned decorative layer and the second sub-patterned decorative layer.

17. The touch panel of claim 16, wherein a portion of the separation layer is further extended to the transparent region, and the sensing device in the transparent region is disposed above the separation layer.

18. The touch panel of claim 16, wherein the separation layer comprises a material of at least one of silicon nitride, silicon oxide and index matching materials.

19. The touch panel of claim 1, wherein the substrate is a glass substrate, a thin glass layer, a plastic plate, a complex plastic plate or a plastic thin film, and the substrate has a light transmittance ratio greater than or equal to 85%.

20. A touch-sensitive display device, comprising:
a touch panel as claimed in claim 1;
a display panel, disposed at a side of the touch panel; and
an adhesive layer, disposed between the display panel and the touch panel, the adhesive layer being used for fixing the touch panel onto a surface of the display panel.

21. The touch-sensitive display device of claim 20, wherein at least one insulating layer is disposed between the sensing device and the substrate, and a refractive index of the insulating layer is between 1.4 and 1.9.

22. The touch-sensitive display device of claim 21, wherein the protection layer is composed of at least one of a silicon nitride (SiNx) layer, a silicon oxide (SiOx) layer and an organic material layer, and the organic material layer has a thickness greater than a thickness of the sensing device.
